(19) United States
(12) Patent Application Publication
(10) Pub. No.: US 2026/0347678 A1
(43) Pub. Date: Nov. 5, 2026

(54) CROSSLINKABLE COMPOSITIONS BASED ON SILANE-CROSSLINKING ORGANIC POLYMERS WITH HIGH THERMAL CONDUCTIVITY

(71) Applicant: WACKER CHEMIE AG, München (DE)

(72) Inventors: Volker STANJEK, München (DE); Sebastian KNÖR, München (DE); Lars ZANDER, München (DE)

(73) Assignee: Wacker Chemie AG, Munich (DE)

(21) Appl. No.: 19/473,815

(22) PCT Filed: Apr. 21, 2023
(86) PCT No.: PCT/EP2023/060410

§ 371 Date: Oct. 9, 2025

(51) Int. Cl. C09K 5/14; C08G 77/46; C08K 3/02; C09D 5/18; C09D 7/61; C09D 183/12; C09J 9/00; C09J 11/04; C09J 183/12

(52) U.S. Cl. CPC C09K 5/14; C08G 77/46; C09D 5/18; C09D 7/61; C09D 183/12; C09J 9/00; C09J 11/04; C09J 183/12; C08K 2003/023; C08K 2201/001; C08K 2201/005

(57) ABSTRACT

A crosslinkable, thermally conductive composition (M) along with methods of making and uses for the same. Where the crosslinkable, thermally conductive composition (M) includes 100 parts by weight of at least one compound (A) of the formula (I)

Y[(CR¹₂)_{b}—SiRₐ(OR²)₃₋ₐ]ₓ (I), and

100 to 1900 parts by weight of at least one filler (B). Where at least 30% by weight of all fillers (B) consists of metallic silicon particles (B1).

The invention relates to crosslinkable compositions with high thermal conductivity based on silane-crosslinking polymers, to processes for the production thereof, and to the use thereof.

Thermally conductive compositions are widely used for thermal management in the automotive and electronics industries. Important formulations include for example thermally conductive adhesives and potting compounds. A further important use is what are known as gap fillers, especially for lithium-ion batteries. Gap fillers are thermally conductive elastomers that completely and permanently fill gaps and cavities in the respective component and minimize thermal resistance, for example between electronic components and cooling housings or heat sinks.

Silicone elastomers are often used as binders for thermally conductive compositions. They have the advantage of being comparatively temperature-resistant and being able to withstand very well the thermal stress to which thermally conductive compositions are often exposed in their end use. Moreover, various curing mechanisms are known, for example silane condensation, hydrosilylation or else peroxidic crosslinking, which allow application of the composition in the form of a liquid or paste with subsequent curing to give a material having the desired elastomeric properties. Corresponding systems are described for example in US2016122611 or WO2022/161634.

However, in many applications silicones are not desirable, since the polydimethylsiloxane chains present therein are extremely surface-active and can drastically reduce the adhesion of components or further coating materials. Especially when applying coats of paint or varnishes, even minimal traces of polydimethylsiloxane are sufficient to result in massive paint or varnish defects. Since shorter polydimethylsiloxane chains additionally have a certain volatility and can therefore also disperse over long distances via ventilation or air-conditioning systems in building complexes, there is a strict ban on the entire substance group in many manufacturing sectors, particularly in the automotive industry.

An alternative technology to silicone-based products could be the use of binders based on what are known as hybrid polymers, i.e. use of polymers with an organic backbone having reactive and crosslinkable alkoxysilyl groups.

Polymer systems having reactive alkoxysilyl groups have long been known. On contact with water or atmospheric moisture, these alkoxysilane-terminated polymers are able to condense with one another with elimination of the alkoxy groups even at room temperature.

One of the most important established uses of such materials is the production of adhesives and sealants for use in construction. Thus, in the cured state adhesives and sealants based on alkoxysilane-crosslinking polymers exhibit not only good adhesion properties on virtually all inorganic substrates used in the construction sector but also very good mechanical properties.

A further advantage of silane-crosslinking systems over numerous other products curable at room temperature (for example over isocyanate-crosslinking systems) is the toxicological safety of the prepolymers.

In addition to “one-component” products, which react and cure with atmospheric moisture and/or traces of water in the substrates to which they have been applied, “two-component” systems also exist. These cure as soon as two components are mixed together, one component of the system usually comprising the silane-crosslinking polymer and the second a water available in suitable form. The latter may be dissolved, emulsified, absorbed on the surface of suitable fillers (for example zeolites) or else chemically reversibly bound.

Silane-crosslinking polymers have been known to those skilled in the art for decades and are available from numerous manufacturers.

A first particular variant of this technology consists of the use of what are known as α-silane-terminated prepolymers. These have reactive alkoxysilyl groups linked to an adjacent urethane unit by a methylene spacer. This class of compounds is highly reactive and does not require either tin catalysts or strong acids or bases to achieve high curing rates on contact with air. Commercially available α-silane terminated prepolymers are Geniosil® STP-E10 or -E30 from Wacker Chemie AG.

A second particular variant, which is of particular interest for adhesives based on silane-crosslinking polymers, is described for example in US2014155545A, corresponding to EP2744842A, which in addition to the silane-crosslinking polymers also contain phenylsilicone resins. The corresponding resin additives also result in products that exhibit significantly higher hardness once fully cured.

A third particular variant, which is of particular interest for sealants based on silane-crosslinking polymers, is described for example in US2017198101A, corresponding to EP3149095A. In addition to the customary, preferably linear silane-crosslinking polymers containing a crosslinkable silane function at both chain ends, products are also described therein that have reactive silane groups at just one chain end.

Despite their widespread use as conventional adhesives and sealants, particularly in the construction sector, there are only very isolated descriptions of systems based on silane-crosslinking polymers having high thermal conductivity. One of these rare mentions can be found in example 5 of US2022119593A, corresponding to EP3924428A. This employs a specific filler mixture of spherical aluminum oxide particles, calcined aluminum oxide particles, and zinc oxide. The filler content is very high, at 90%. Such high contents of specific filler mixtures are indispensable for achieving high thermal conductivity, since the silane-terminated polymers themselves have only very low thermal conductivity of the order of 0.15-0.20 W/mK.

The two-component system described in example 5 of US2022119593A, corresponding to EP3924428A, has a thermal conductivity of 2.8-2.9 W/mK. This is of a quite considerable order. However, for many uses, for example for high-performance batteries, even higher thermal conductivities would be desirable.

It was accordingly an object of the invention to develop compositions based on silane-crosslinking polymers with an organic, i.e. non-polysiloxane-containing, backbone having a thermal conductivity that is improved still further by comparison with the prior art.

This object was surprisingly achieved by the present invention.

This invention provides crosslinkable, thermally conductive compositions (M) comprising:
100 parts by weight of at least one compound (A) of the formula

Y—[(CR¹₂)_{b}—SiRₐ(OR²)₃₋ₐ]ₓ (I),

where
Y is an x-valent organic polymer radical attached via nitrogen, oxygen, sulfur or carbon,
R may be identical or different and is a monovalent, optionally substituted hydrocarbon radical,
R¹ may be identical or different and is a hydrogen atom or a monovalent, optionally substituted hydrocarbon radical that can be attached to the carbon atom via nitrogen, phosphorus, oxygen, sulfur or a carbonyl group,
R² may be identical or different and is a hydrogen atom or a monovalent, optionally substituted hydrocarbon radical,
x is an integer from 1 to 10, preferably 1, 2 or 3, more preferably 1 or 2,
a may be identical or different and is 0, 1 or 2, preferably 0 or 1, and
b may be identical or different and is an integer from 1 to 10, preferably 1, 3 or 4, more preferably 1 or 3, especially 1, and
100 to 1900 parts by weight of at least one filler (B),
   where at least 30% by weight of all fillers (B) consists of metallic silicon particles (B1).

In the context of the present invention, the terms heat-conducting, thermoconductive or thermally conductive are synonymous.

In order not to create an excessive number of pages in the description of the present invention, only the preferred embodiments of the individual features are specified hereinbelow.

However, the expert reader should explicitly understand this type of disclosure as meaning that every combination of different preference levels is also explicitly disclosed and explicitly desired therewith.

The invention is based on the surprising discovery that the silicon particles of the invention (B1) are capable of significantly improving the thermal conductivity of the crosslinkable compositions (M) still further compared to the values achieved in the prior art. At the same time, their low density makes it possible to provide thermally conductive compositions (M) having comparatively low density.

### Compound (A)

Examples of radicals R in the formula (I) are alkyl radicals, such as the methyl, ethyl, n-propyl, isopropyl, 1-n-butyl, 2-n-butyl, isobutyl, tert-butyl, n-pentyl, isopentyl, neopentyl, and tert-pentyl radical; hexyl radicals, such as the n-hexyl radical; heptyl radicals, such as the n-heptyl radical; octyl radicals, such as the n-octyl radical, isooctyl radicals and the 2,2,4-trimethylpentyl radical; nonyl radicals, such as the n-nonyl radical; decyl radicals, such as the n-decyl radical; dodecyl radicals, such as the n-dodecyl radical; octadecyl radicals, such as the n-octadecyl radical; cycloalkyl radicals, such as the cyclopentyl, cyclohexyl, cycloheptyl, and methylcyclohexyl radicals; alkenyl radicals, such as the vinyl, 1-propenyl, and 2-propenyl radical; aryl radicals, such as the phenyl, naphthyl, anthryl, and phenanthryl radical; alkaryl radicals, such as o-, m-, and p-tolyl radicals, xylyl radicals and ethylphenyl radicals; and aralkyl radicals, such as the benzyl radical and the α- and β-phenylethyl radical.

Examples of substituted radicals R are haloalkyl radicals, such as the 3,3,3-trifluoro-n-propyl radical, the 2,2,2,2′,2′,2′-hexafluoroisopropyl radical, and the heptafluoroisopropyl radical, and haloaryl radicals, such as the o-, m-, and p-chlorophenyl radical.

Radical R is preferably monovalent hydrocarbon radicals having 1 to 6 carbon atoms and optionally substituted by halogen atoms, more preferably alkyl radicals having 1 or 2 carbon atoms, especially the methyl radical.

Examples of radicals R¹ are a hydrogen atom, the radicals specified for R, and optionally substituted hydrocarbon radicals attached to the carbon atom via nitrogen, phosphorus, oxygen, sulfur, carbon or a carbonyl group.

The radical R¹ is preferably a hydrogen atom or hydrocarbon radicals having 1 to 20 carbon atoms, especially a hydrogen atom.

Examples of radical R² are a hydrogen atom and the examples given for radical R.

The radical R² is preferably a hydrogen atom or alkyl radicals having 1 to 10 carbon atoms, more preferably alkyl radicals having 1 to 4 carbon atoms, optionally substituted by halogen atoms, especially the methyl or ethyl radical.

For the purposes of the present invention, polymers on which the organic polymer radical Y is based are to be understood as meaning any polymers in which at least 50%, preferably at least 70%, more preferably at least 90%, of all bonds in the main chain are carbon-carbon, carbon-nitrogen or carbon-oxygen bonds. Particularly preferably, all bonds in the main chain of the polymer radicals Y consist of carbon-carbon, carbon-nitrogen or carbon-oxygen bonds.

Silicones with a backbone consisting essentially, i.e. to an extent of at least 50% of all bonds, of silicon-oxygen bonds are explicitly not polymers on which the polymer radical Y is based.

Examples of polymer radicals Y are polyester, polyether, polyurethane, polyalkylene, and polyacrylate radicals.

Polymer radical Y is preferably organic polymer radicals comprising as the polymer chain polyoxyalkylenes, such as polyoxyethylene, polyoxypropylene, polyoxybutylene, polyoxytetramethylene, polyoxyethylene-polyoxypropylene copolymer, and polyoxypropylene-polyoxybutylene copolymer; hydrocarbon polymers, such as polyisobutylene and copolymers of polyisobutylene with isoprene; polychloroprenes; polyisoprenes; polyurethanes; polyesters; polyacrylates; polymethacrylates; vinyl polymer or polycarbonates and which are preferably attached to the —[(CR¹₂)_{b}—SiRₐ(OR²)₃₋ₐ] group(s) via —O—C(═O)—NH—, —NH—C(═O)O—, —NH—C(═O)—NH—, —NR′—C(═O)—NH—, NH—C(═O)—NR′—, —NH—C(═O)—, —C(═O)—NH—, —C(═O)—O—, —O—C(═O)—, —O—C(═O)—O—, —S—C(═O)—NH—, —NH—C(═O)—S—, —C(═O)—S—, —S—C(═O)—, —S—C(═O)—S—, —C(═O)—, —S—, —O—, —NR′—, where R′ may be identical or different and is as defined for R or is a —CH(COOR″)—CH₂—COOR″ group, in which R″ may be identical or different and is as defined for R.

The radical R′ is preferably a —CH(COOR″)—CH₂—COOR″ group or an optionally substituted hydrocarbon radical having 1 to 20 carbon atoms, more preferably a linear, branched or cyclic alkyl group having 1 to 20 carbon atoms or an aryl group having 6 to 20 carbon atoms and optionally substituted by halogen atoms.

Examples of radicals R′ are cyclohexyl, cyclopentyl, n- and isopropyl, n-, iso- and t-butyl radical, the various stereoisomers of the pentyl radical, hexyl radical or heptyl radical and also the phenyl radical.

The radicals R″ are preferably alkyl groups having 1 to 10 carbon atoms, more preferably methyl, ethyl or propyl radicals.

The component (A) may include the —[(CR¹₂)_{b}—SiRₐ(OR²)₃₋ₐ] groups attached in the described manner at any position in the polymer, for example in chain and/or terminal positions.

More preferably, the radical Y in the formula (I) is x-valent organic polymer radicals attached via nitrogen, oxygen, sulfur or carbon that contain polyurethanes or polyoxyalkylenes as polymer chain, especially polyurethane radicals having terminally attached —[(CR¹₂)_{b}—SiRₐ(OR²)₃₋ₐ] groups or polyoxyalkylene radicals having terminally attached —[(CR¹₂)_{b}—SiRₐ(OR²)₃₋ₐ] groups, where the radicals and indices are as defined above. The radicals Y are preferably linear or have 1 to 3 branching points. They are more preferably linear.

The polyurethane radicals Y are preferably those in which the chain ends are attached to the —[(CR¹₂)—SiRₐ(OR²)₃₋ₐ] group(s) via —NH—C(═O)O—, —NH—C(═O)—NH—, —NR′—C(═O)—NH— or —NH—C(═O)—NR′—, especially via —O—C(═O)—NH— or —NH—C(═O)—NR′—, where all radicals and indices are as defined above. The polyurethane radicals Y can preferably be produced from linear or branched polyoxyalkylenes, especially from polypropylene glycols, and di- or polyisocyanates. The radicals Y preferably have average molar masses Mₙ (number average) of from 400 to 30 000 g/mol, preferably from 3000 to 20 000 g/mol. Suitable methods for preparing a corresponding component (A) and also examples of component (A) itself are described inter alia in EP1093482B1 (paragraphs [0014]-[0023], [0039]-[0055] and in example 1 and comparative example 1), corresponding to U.S. Pat. No. 6,884,852B, or in EP1641854B1 (paragraphs [0014]-[0035]), examples 4 and 6 and in comparative examples 1 and 2), corresponding to US2007167598A, which are included in the disclosure content of the present application.

The number-average molar mass Mₙ is determined in the context of the present invention by size-exclusion chromatography (SEC) on a Styragel HR3-HR4-HR5-HR5 column set from Waters Corp. USA in THF with an injected volume of 100 μl against a polystyrene standard and at 60 °C, a flow rate of 1.2 ml/min, and detection by RI (refractive index detector).

The polyoxyalkylene radicals Y are preferably linear or branched polyoxyalkylene radicals, more preferably polyoxypropylene radicals, the chain ends of which are preferably attached to the —[(CR¹₂)_{b}—SiRₐ(OR²)₃₋ₐ] group(s) via —O—C(═O)—NH— or —O—, where the radicals and indices are as defined above. Preferably, at least 85%, more preferably at least 90%, especially at least 95%, of all chain ends are attached to the —[(CR¹₂)_{b}—SiRₐ(OR²)₃₋ₐ] group via —O—C(═O)—NH—. The polyoxyalkylene radicals Y preferably have average molar masses Mₙ of 400 to 30 000 g/mol, preferably 3000 to 20 000 g/mol. Suitable methods for preparing a corresponding component (A) and also examples of component (A) itself are described inter alia in EP1535940B1 (paragraphs [0005]-[0025] and in examples 1-3 and comparative examples 1-4), corresponding to US2005119436A, or EP1896523B1 (paragraphs [0008]-[0047]), corresponding to US2010016537A, which are included in the disclosure content of the present application.

In a particular embodiment of the invention, the compounds (A) are wholly or partly polyurethanes or polypropylene glycols having just one reactive silyl group of the formula —[(CR¹₂)_{b}—SiRₐ(OR²)₃₋ₐ], where the radicals and indices are as defined above. In other words they are compounds (A) of the formula (I) where x is 1. In this case, the other chain ends are preferably terminated by hydroxyl groups, aryl groups having 6 to 20 carbon atoms or alkyl groups having 1 to 20 carbon atoms, the latter being particularly preferred.

More preferably, in this particular embodiment of the invention, the compounds (A) are wholly or partly linear polyurethanes or polypropylene glycols having one chain end that is terminated by a branched, unbranched or cyclic alkyl group having 1 to 20 carbon atoms, and a second chain end bearing a reactive silyl group of the formula —[(CR¹₂)_{b}—SiRₐ(OR²)₃₋ₐ].

The end groups of the compounds (A) used according to the invention are preferably those of the general formulas

—NH—C(═O)—NR′—(CR¹₂)_{b}—SiRₐ(OR²)₃₋ₐ (II),

—O—C(═O)—NH—(CR¹₂)_{b}—SiRₐ(OR²)₃₋ₐ (III) or

—O—(CR¹₂)_{b}—SiRₐ(OR²)₃₋ₐ (IV),

where the radicals and indices are as defined above.

Where the compounds (A) are polyurethanes, which is preferred, they preferably have one or more of the following end groups
—NH—C(═O)—NR′—(CH₂)₃—Si(OCH₃)₃,
—NH—C(═O)—NR′—(CH₂)₃—Si(OC₂H₅)₃,
—O—C(═O)—NH—(CH₂)₃—Si(OCH₃)₃ or
—O—C(═O)—NH—(CH₂)₃—Si(OC₂H₅)₃,
   where R′ is as defined above.

Where the compounds (A) are polypropylene glycols, which is particularly preferred, they preferably have one or more of the following end groups
—O—(CH₂)₃—Si(CH₃)(OCH₃)₂,
—O—(CH₂)₃—Si(OCH₃)₃,
—O—C(═O)—NH—(CH₂)₃—Si(OC₂H₅)₃,
—O—C(═O)—NH—CH₂—Si(CH₃)(OC₂H₅)₂,
—O—C(═O)—NH—CH₂—Si(OCH₃)₃,
—O—C(═O)—NH—CH₂—Si(CH₃)(OCH₃)₂ or
—O—C(═O)—NH—(CH₂)₃—Si(OCH₃)₃,
   the latter two end groups being particularly preferred.

The average molecular weights Mₙ of the compounds (A) are preferably at least 200 g/mol, more preferably at least 1000 g/mol, especially at least 3000 g/mol, and preferably at most 30 000 g/mol, more preferably at most 20 000 g/mol, especially at most 13 000 g/mol.

Where the radicals Y are polyurethanes or polyethers, which is preferred, the average molecular weights Mₙ of the compounds (A) are preferably obtained by adding the abovementioned preferred molar masses of the radicals Y and the masses for the respective binder and/or end groups.

The viscosity of the compounds (A) is preferably at least 0.1 Pa·s, more preferably at least 0.5 Pa·s, and particularly preferably at least 1 Pa·s, and preferably at most 100 Pa·s, more preferably at most 10 Pa·s, and particularly preferably at most 5 Pa·s, in each case measured at 20 °C.

The viscosity of the polymers (A) used according to the invention is determined in the context of the present invention in accordance with ISO 2555 after thermal equilibration at 20 °C using a DV 3 P rotational viscometer from A. Paar (Brookfield Systems) using spindle 5 at 2.5 rpm.

The compounds (A) used according to the invention are commercially available products or can be prepared by standard chemical methods.

The polymers (A) can be prepared by known methods such as addition reactions, for example hydrosilylation, Michael addition, Diels-Alder addition or reactions between isocyanate-functional compounds with compounds having isocyanate-reactive groups.

The component (A) used according to the invention may comprise just one type of compound of the formula (I) or else mixtures of different types of compounds of the formula (I). The component (A) may comprise exclusively compounds of the formula (I) in which more than 90%, preferably more than 95%, and more preferably more than 98%, of all the silyl groups attached to the radical Y are identical. However, it is in that case also possible to use a component (A) that at least in part comprises compounds of the formula (I) in which different silyl groups are attached to a radical Y. Lastly, it is also possible to use as component (A) mixtures of different compounds of the formula (I) in which a total of at least 2 different types of silyl groups attached to radicals Y are present, but where all silyl groups attached to a particular radical Y are identical.

### Filler (B)

Preferably, at least 30% by weight, more preferably at least 40% by weight, and particularly preferably at least 60% by weight, of all fillers (B) consists of metallic silicon particles (B1).

Where the fillers (B) do not consist exclusively of metallic silicon particles (B1), they preferably comprise further thermally conductive fillers (B2) that consist of materials having a thermal heat conductivity of at least 5 W/mK. Overall, the fillers (B) consist preferably to an extent of at least 60% by weight, more preferably to an extent of at least 70% by weight, and particularly preferably to an extent of at least 80% by weight, of fillers (B1) and—if present—(B2). In an especially preferred embodiment of the invention, the fillers (B) consist exclusively of fillers (B1) and—if present—(B2).

The median diameter ×50 of the metallic silicon particles of the invention (B1) is in the range 0.5-250 μm, preferably in the range 10-200 μm, preferably in the range 20-180 μm, more preferably in the range 30-160 μm, particularly preferably in the range 35-150 μm.

Particularly preferably, the silicon particles (B1) having the abovementioned preferred or more preferred median diameters ×50 additionally have a width/length ratio (aspect ratio w/1) of at least 0.76.

The silicon particles (B1) are preferably produced from a molten state.

More preferably, the silicon particles (B1) are brought into their solid particle shape from a silicon melt by spraying or atomization and subsequent cooling.

The thermally conductive compositions of the invention (M) preferably contain at least 27% by weight of metallic silicon particles (B1), more preferably at least 36% by weight, and particularly preferably at least 54% by weight. If the content of metallic silicon particles (B1) in the compositions (M) is too low, the desired advantageous effects of this component, for example the low density and high thermal conductivity, can no longer be achieved to the desired extent.

The metallic silicon particles of the invention (B1) may be of any regular or irregular shape. For example, the particles may be spherical, round, ellipsoidal, cylindrical, fibrous, square, sharp-edged, potato-shaped, nodular or “spattered” in shape. Preference is given to metallic silicon particles of the invention (B1) that are predominantly ellipsoidal, potato-shaped, round or spherical in shape. The silicon particles (B1) preferably have a width/length ratio (aspect ratio w/1) of at least 0.76, more preferably of at least 0.77, and especially preferably of at least 0.78. Even greater preference is given to silicon particles (B1) having a width/length ratio of at least 0.79.

The distribution width of the particle size (span) is defined as span=(×90−×10)/×50, where ×90, ×50, and ×10 represent the 90th, 50th, and 10th percentiles. The distribution width of the metallic silicon particles of the invention (B1) is in principle unrestricted. The metallic silicon particles of the invention (B1) preferably have a span of greater than 0.28, more preferably greater than 0.30, particularly preferably greater than 0.35. In a preferred embodiment the span is between 0.40 and 2.5, preferably between 0.41 and 2.2, and particularly preferably between 0.5 and 2.0.

It is immaterial whether a single fraction of silicon particles (B1) in which the span is within the range of the invention is used or whether two or more fractions of silicon particles are mixed to achieve the particle size distribution width of the invention in the silicon particles of the invention (B1). If two or more fractions of silicon particles are mixed, this may be done prior to the mixing with one or more components of the composition of the invention, or the fractions of silicon particles may also be separately mixed with one or more components of the composition of the invention. The order of addition is immaterial.

Preferably, a maximum of four fractions of silicon particles (B1) are mixed, preferably a maximum of three fractions of silicon particles (B1) are mixed, more preferably a maximum of two fractions of silicon particles of the invention (B1) are used, particularly preferably only a single silicon powder of the invention (B1) is used.

A disadvantage of silicon particles having an average particle size of greater than 250 μm is that such large-grained silicon particles often do not fit into the fine gaps between components that are to be filled with gap fillers, for example.

A disadvantage of very fine silicon particles or milled silicon particles is that such particles have a relatively large surface area and bind a large amount of polymer. This increases the viscosity of the composition greatly, so that only mixtures having relatively low filler contents and thus lower thermal conductivities are obtainable. At higher contents of fine silicon particles as filler, the composition would become very stiff and no longer processable using classical processes, for example a dispenser.

Furthermore, under certain conditions metallic silicon particles are combustible and their dusts pose an explosion hazard. The risk of dust formation, the combustibility, and the explosion hazard of metal powders increase greatly with decreasing particle size. The low minimum ignition energy of fine metallic silicon particles makes them more hazardous to handle and necessitates laborious and costly safety precautions when worked with in industry.

In a preferred embodiment, the silicon particles of the invention (B1) contain not more than 1.5% by weight of silicon particles having a maximum diameter of 2 μm, preferably not more than 1% by weight, more preferably not more than 0.5% by weight, in each case based on the total amount of silicon particles (B1). Particularly preferred silicon particles (B1) are essentially free of particle fractions smaller than 2 μm. The term “essentially free of” is understood as meaning that the presence of such particles is tolerated to the extent that they are an “impurity” of the particles of the invention (B1) and do not disrupt the inventive effect thereof.

The term “maximum diameter” describes the longest possible distance between two particle surfaces within a particle.

The silicon particles of the invention (B1) preferably contain less than 20% by weight, preferably less than 15% by weight, more preferably less than 10% by weight, of a particle fraction having a diameter of less than or equal to 20 μm, in each case based on the total amount of silicon particles.

Metallic silicon has a number of very advantageous properties for use as thermally conductive filler (B1). For example the exceptionally high thermal conductivity of silicon particles (B1) improves the thermal conductivity of the thermally conductive compositions (M) produced therefrom. The low density of the silicon particles (B1) reduces the weight of the composition and of the components produced therefrom and helps to cut costs. The low electrical conductivity makes it possible to produce electrically insulating components and improves dielectric strength. The low Mohs hardness of the silicon particles (B1) reduces abrasion during processing. Since the advantages mentioned are entirely or partially lost with decreasing silicon purity, the purity of the silicon particles of the invention (B1) and thus the silicon content is at least 80% by weight, preferably at least 90% by weight, more preferably at least 95% by weight.

Various methods for producing finely divided metal particles having a “spattered”, nodular, ellipsoidal, potato-shaped, round or spherical shape are known from the prior art. The silicon particles of the invention (B1) are in the final step of production preferably produced from a molten state, as a result of which they have a smooth surface and rounded surface shapes and are essentially free of fracture sites, sharp edges and sharp corners. This distinguishes them from conventional milled particles that have been brought into their final shape by crushing, grinding or milling, for example. It is immaterial here whether the particles are comminuted in a cold state in a first process step, for example by milling, and subsequently brought into a molten form by heating above their melting point, for example by heat treatment in a hot zone, for example by means of a plasma, or whether a silicon melt is initially produced and subsequently comminuted, for example by atomization. It is preferable when the silicon particles of the invention are brought into their solid particle shape of the invention by spraying or atomization of a silicon melt and subsequent cooling.

Suitable processes for producing the silicon particles of the invention (B1) are known to those skilled in the art and are described for example in chapter 2.2 of “Pulvermetallurgie: Technologien und Werkstoffe” [Powder metallurgy: Technologies and materials], Schatt, Werner, Wieters, Klaus-Peter, Kieback, Bernd, pp. 5-48, ISBN 978-3-540-681112-0, e-book: https://doi.org/10.1007/978-3-540-68112-0_2. Preferred processes for producing the silicon particles of the invention (B1) are inert-gas spraying, also known as gas atomization, pressurized-water spraying, also known as liquid atomization or water-atomization processes, or melt-spinning processes, also known as centrifugal atomization or rotational atomization.

The described processes make it possible to produce metallic silicon particles in a widely varying particle size range, in particular in an average particle size range from a few micrometers to a few millimeters. In addition, the metallic silicon particles can be produced in widely varying grain shapes and with a very variable particle size distribution width, for example “spattered”, that is to say very irregular, nodular, ellipsoidal, potato-shaped, round or spherical.

The process for producing the metallic silicon particles of the invention (B1) is preferably to be performed such that the particles are obtained in the preferred predominantly nodular, “spattered”, ellipsoidal, potato-shaped, round or spherical shape and are essentially free of sharp-edged or pointed particles.

More preferably, the process for producing the metallic silicon particles of the invention (B1) is to be performed such that the particles are obtained in their preferred predominantly ellipsoidal, potato-shaped, round or spherical shape, characterized in that the width/length ratio (aspect ratio w/l) is preferably at least 0.76, preferably at least 0.77, more preferably at least 0.78, especially at least 0.79, and are essentially free of “spattered”, nodular, sharp-edged or pointed particles. In a subsequent process step the solidified particles may be separated by size by commonly used processes, for example by classifying, by sieving or by sifting. These processes make it possible to remove agglomerates and particles that are stuck together, but essentially no particles are destroyed. “Predominantly rounded” and “essentially free of” are understood as meaning that the presence of such particles is tolerated to the extent that they are an “impurity” of the particles of the invention (B1) in a content of not more than 10% by weight, preferably not more than 5% by weight, and do not disrupt the inventive effect thereof.

The compositions of the invention (M) may comprise as fillers (B) not just the metallic silicon particles (B1) but also further thermally conductive fillers (B2) that consist of materials having a thermal heat conductivity of at least 5 W/mK and also any desired further fillers (B3). Fillers (B) here are any inorganic materials that are solid, crystalline or amorphous at temperatures below 200 °C.

Further fillers used in addition to the metallic silicon particles (B1) are preferably thermally conductive fillers (B2). Examples of thermally conductive fillers (B2) are magnesium oxide, metallic aluminum powder, metallic silver powder, zinc oxide, boron nitride, silicon carbide, aluminum nitride, aluminum hydroxide, aluminum oxide, graphite, etc. Preferred thermally conductive fillers (B2) are aluminum powder, magnesium oxide, aluminum hydroxide, zinc oxide, and aluminum oxide. Particularly preferred thermally conductive fillers (B2) are aluminum hydroxide, aluminum oxide, and zinc oxide.

Examples of any desired further fillers (B3) are non-reinforcing fillers, i.e. fillers having a BET surface area of preferably up to 50 m²/g, such as quartz, diatomaceous earth, calcium silicate, zirconium silicate, talc, kaolin, zeolites, barium sulfate, calcium carbonate, gypsum or glass powder; reinforcing fillers, i.e. fillers having a BET surface area of more than 50 m²/g, such as fumed silica, precipitated silica, precipitated chalk, carbon black, such as furnace and acetylene black having a large BET surface area or graphite; hollow spherical fillers, such as ceramic microspheres, glass beads or fibrous fillers. The fillers mentioned may be hydrophobized, for example by treatment with organosilanes or organosiloxanes or with stearic acid or by etherification of hydroxyl groups to alkoxy groups.

The shape of the further fillers (B2) and/or (B3) is in principle unrestricted. The particles may for example be spherical, ellipsoidal, acicular, tubular, plate-like, fibrous, “spattered”, nodular or irregular in shape. They are preferably predominantly round, spherical, ellipsoidal, potato-shaped or irregular in shape. The median diameter of the further fillers (B2) and/or (B3) is preferably in the range of 0.01-250 μm, more preferably in the range of 0.1-200 μm, particularly preferably in the range of 0.2-180 μm, especially in the range of 0.4-150 μm.

Fillers (B) of very high density are disadvantageous to employ in airplanes and electric vehicles, for example, since they increase the weight of the components very substantially. As further fillers (B2) and/or (B3), preference is therefore given to materials having a density of not more than 5.0 g/cm³, preferably not more than 4.0 g/cm³, more preferably not more than 3.0 g/cm³.

The compositions of the invention (M) preferably contain not more than 24% by weight, more preferably not more than 10% by weight, of fillers (B2) and/or (B3) having a density of greater than 5.0 g/cm³, and particularly preferably none at all.

In many uses it is undesirable for the thermally conductive composition to have an electrical conductivity, since this can lead for example to short circuits. The composition of the invention (M) preferably contains exclusively fillers (B) having a specific resistance of at least 1 Ω·mm²/m.

The total amount of fillers (B) in the thermally conductive compositions of the invention (M) is 100-1900 parts by weight of (B) per 100 parts by weight of (A), preferably 150-1850 parts by weight of (B) per 100 parts by weight of (A), and more preferably 200-1800 parts by weight of (B) per 100 parts by weight of (A).

Preferably, at least 90% by weight, more preferably at least 95% by weight, and particularly preferably at least 98%, of all the fillers (B) used in the compositions of the invention (M) are thermally conductive fillers (B1) and optionally (B2). In a particularly advantageous execution of the invention, the compositions of the invention (M) comprise exclusively thermally conductive fillers (B1) and optionally (B2).

In addition to the components (A) and (B) used, the compositions (M) produced according to the invention may comprise any further substances that have also been used to date in crosslinkable compositions and that are different to components (A) and (B), such as those selected from the group consisting of nitrogen-containing organosilicon compounds (C), non-reactive plasticizers (D), silicone resins (E), catalysts (F), adhesion promoters (G), water scavengers (H), additives (I), and aggregates (J).

### Component (C)

Component (C) that is optionally used is preferably organosilicon compounds comprising units of the formula

DₑSi(OR⁴)_{d}R³_{c}O_{(4-c-d-e)/2} (V),

in which
R³ may be identical or different and is a monovalent, optionally substituted SiC-bonded, nitrogen-free organic radical,
R⁴ may be identical or different and is a hydrogen atom or optionally substituted hydrocarbon radicals,
D may be identical or different and is a monovalent, SiC-bonded radical having at least one nitrogen atom not attached to a carbonyl group (C═O),
c is 0, 1, 2 or 3, preferably 0 or 1,
d is 0, 1, 2 or 3, preferably 1, 2 or 3, more preferably 2 or 3, and
e is 0, 1, 2, 3 or 4, preferably 1,
   with the proviso that the sum of c+d+e is less than or equal to 4 and at least one radical D is present per molecule.

Organosilicon compounds (C) optionally used according to the invention may be either silanes, i.e. compounds of the formula (V) where c+d+e=4, or siloxanes, i.e. compounds comprising units of the formula (V) where c+d+e≤3, preference being given to silanes.

Examples of radical R³ are the examples given for R.

Radical R³ is preferably hydrocarbon radicals having 1 to 18 carbon atoms and optionally substituted by halogen atoms, more preferably hydrocarbon radicals having 1 to 5 carbon atoms, especially the methyl radical.

Examples of optionally substituted hydrocarbon radicals R⁴ are the examples given for radical R.

Radicals R⁴ are preferably a hydrogen atom or hydrocarbon radicals having 1 to 18 carbon atoms and optionally substituted by halogen atoms, more preferably a hydrogen atom or hydrocarbon radicals having 1 to 10 carbon atoms, especially methyl or ethyl radicals.

Examples of radicals D are radicals of the formulas H₂N(CH₂)₃—, H₂N(CH₂)₂NH(CH₂)₃—, H₂N(CH₂)₂NH(CH₂)₂NH(CH₂)₃—, H₃CNH(CH₂)₃—, C₂H₅NH(CH₂)₃—, C₃H₇NH(CH₂)₃—, C₄H₉NH(CH₂)₃—, C₅H₁₁NH(CH₂)₃—, C₆H₁₃NH(CH₂)₃—, C₇H₁₅NH(CH₂)₃—, H₂N(CH₂)₄—, H₂N—CH₂—CH(CH₃)—CH₂—, H₂N(CH₂)₅—, cyclo-C₅H₉NH(CH₂)₃—, cyclo-C₆H₁₁NH(CH₂)₃—, phenyl-NH(CH₂)₃—, (CH₃)₂N(CH₂)₃—, (C₂H₅)₂N(CH₂)₃—, (C₃H₇)₂N(CH₂)₃—, (C₄H₉)₂N(CH₂)₃—, (C₅H₁₁)₂N(CH₂)₃—, (C₆H₁₃)₂N(CH₂)₃—, (C₇H₁₅)₂N(CH₂)₃—, H₂N(CH₂)—, H₂N(CH₂)₂NH(CH₂)—, H₂N(CH₂)₂NH(CH₂)₂NH(CH₂)—, H₃CNH(CH₂)—, C₂H₅NH(CH₂)—, C₃H₇NH(CH₂)—, C₄H₉NH(CH₂)—, C₅H₁₁NH(CH₂)—, C₆H₁₃NH(CH₂)—, C₇H₁₅NH(CH₂)—, cyclo-C₅H₉NH(CH₂)—, cyclo-C₆H₁₁NH(CH₂)—, phenyl-NH(CH₂)—, (CH₃)₂N(CH₂)—, (C₂H₅)₂N(CH₂)—, (C₃H₇)₂N(CH₂)—, (C₄H₉)₂N(CH₂)—, (C₅H₁₁)₂N(CH₂)—, (C₆H₁₃)₂N(CH₂)—, (C₇H₁₅)₂N(CH₂)—, (CH₃O)₃Si(CH₂)₃NH(CH₂)₃—, (C₂H₅O)₃Si(CH₂)₃NH(CH₂)₃—, (CH₃O)₂(CH₃)Si(CH₂)₃NH(CH₂)₃—, and (C₂H₅O)₂(CH₃)Si(CH₂)₃NH(CH₂)₃— and reaction products of the above primary amino groups with compounds containing double bonds or epoxide groups reactive toward primary amino groups.

The radical D is preferably the H₂N(CH₂)₃—, H₂N(CH₂)₂NH(CH₂)₃— or cyclo-C₆H₁₁NH(CH₂)₃-radical.

Examples of silanes of the formula (V) optionally used according to the invention are H₂N(CH₂)₃—Si(OCH₃)₃, H₂N(CH₂)₃—Si(OC₂H₅)₃, H₂N(CH₂)₃—Si(OCH₃)₂CH₃, H₂N(CH₂)₃—Si(OC₂H₅)₂CH₃, H₂N(CH₂)₂NH(CH₂)₃—Si(OCH₃)₃, H₂N(CH₂)₂NH(CH₂)₃—Si(OC₂H₅)₃, H₂N(CH₂)₂NH(CH₂)₃—Si(OCH₃)₂CH₃, H₂N(CH₂)₂NH(CH₂)₃—Si(OC₂H₅)₂CH₃, H₂N(CH₂)₂NH(CH₂)₃—Si(OH)₃, H₂N(CH₂)₂NH(CH₂)₃—Si(OH)₂CH₃, H₂N(CH₂)₂NH(CH₂)₂NH(CH₂)₃—Si(OCH₃)₃, H₂N(CH₂)₂NH(CH₂)₂NH(CH₂)₃—Si(OC₂H₅)₃, cyclo-C₆H₁₁NH(CH₂)₃—Si(OCH₃)₃, cyclo-C₆H₁₁NH(CH₂)₃—Si(OC₂H₅)₃, cyclo-C₆H₁₁NH(CH₂)₃—Si(OCH₃)₂CH₃, cyclo-C₆H₁₁NH(CH₂)₃—Si(OC₂H₅)₂CH₃, cyclo-C₆H₁₁NH(CH₂)₃—Si(OH)₃, cyclo-C₆H₁₁NH(CH₂)₃—Si(OH)₂CH₃, phenyl-NH(CH₂)₃—Si(OCH₃)₃, phenyl-NH(CH₂)₃—Si(OC₂H₅)₃, phenyl-NH(CH₂)₃—Si(OCH₃)₂CH₃, phenyl-NH(CH₂)₃—Si(OC₂H₅)₂CH₃, phenyl-NH(CH₂)₃—Si(OH)₃, phenyl-NH(CH₂)₃—Si(OH)₂CH₃, HN((CH₂)₃—Si(OCH₃)₃)₂, HN((CH₂)₃—Si(OC₂H₅)₃)₂HN((CH₂)₃—Si(OCH₃)₂CH₃)₂, HN((CH₂)₃—Si(OC₂H₅)₂CH₃)₂, cyclo-C₆H₁₁NH(CH₂)—Si(OCH₃)₃, cyclo-C₆H₁₁NH(CH₂)—Si(OC₂H₅)₃, cyclo-C₆H₁₁NH(CH₂)—Si(OCH₃)₂CH₃, cyclo-C₆H₁₁NH(CH₂)—Si(OC₂H₅)₂CH₃, cyclo-C₆H₁₁NH(CH₂)—Si(OH)₃, cyclo-C₆H₁₁NH(CH₂)—Si(OH)₂CH₃, phenyl-NH(CH₂)—Si(OCH₃)₃, phenyl-NH(CH₂)—Si(OC₂H₅)₃, phenyl-NH(CH₂)—Si(OCH₃)₂CH₃, phenyl-NH(CH₂)—Si(OC₂H₅)₂CH₃, phenyl-NH(CH₂)—Si(OH)₃, and phenyl-NH(CH₂)—Si(OH)₂CH₃ and partial hydrolysates thereof, with preference given to H₂N(CH₂)₂NH(CH₂)₃—Si(OCH₃)₃, H₂N(CH₂)₂NH(CH₂)₃—Si(OC₂H₅)₃, H₂N(CH₂)₂NH(CH₂)₃—Si(OCH₃)₂CH₃, cyclo-C₆H₁₁NH(CH₂)₃—Si(OCH₃)₃, cyclo-C₆H₁₁NH(CH₂)₃—Si(OC₂H₅)₃ and cyclo-C₆H₁₁NH(CH₂)₃—Si(OCH₃)₂CH₃ and partial hydrolysates thereof, with particular preference given to H₂N(CH₂)₂NH(CH₂)₃—Si(OCH₃)₃, H₂N(CH₂)₂NH(CH₂)₃—Si(OCH₃)₂CH₃, cyclo-C₆H₁₁NH(CH₂)₃—Si(OCH₃)₃, cyclo-C₆H₁₁NH(CH₂)₃—Si(OCH₃)₂CH₃ and partial hydrolysates thereof.

Organosilicon compounds (C) optionally used according to the invention may also take on the role of a curing catalyst or co-catalyst in the compositions of the invention (M).

In addition, the organosilicon compounds (C) optionally used according to the invention may act as adhesion promoters and/or as water scavengers.

Organosilicon compounds (C) optionally used according to the invention are commercial products or can be produced by standard chemical methods.

If the compositions of the invention (M) contain component (C), the amounts involved are preferably 0.1 to 25 parts by weight, more preferably 0.2 to 20 parts by weight, especially 0.5 to 15 parts by weight, in each case based on 100 parts by weight of component (A). The compositions of the invention (M) preferably contain component (C).

### Component (D)

Non-reactive plasticizers (D) optionally used may be any non-reactive plasticizers that have also been used to date in crosslinkable organopolysiloxane compositions.

Non-reactive plasticizers (D) are preferably organic compounds selected from the groups of substances consisting of
fully esterified aromatic or aliphatic carboxylic acids,
fully esterified derivatives of phosphoric acid,
fully esterified derivatives of sulfonic acids,
branched or unbranched saturated hydrocarbons,
polystyrenes,
polybutadienes,
polyisobutylenes,
polyesters or
polyethers.

Non-reactive plasticizers (D) optionally used according to the invention are preferably ones that do not react either with water or with components (A) and (B) at temperatures <80 °C, are liquid at 20 °C and 1013 hPa, and have a boiling point of >250 °C at 1013 hPa.

Examples of carboxylic esters (D) are phthalic esters, for example dioctyl phthalate, diisooctyl phthalate, diisononyl phthalate, diisodecyl phthalate, and diundecyl phthalate; perhydrogenated phthalic esters, for example diisononyl cyclohexane-1,2-dicarboxylate and dioctyl cyclohexane-1,2-dicarboxylate; adipic esters, for example dioctyl adipate; benzoic esters; esters of trimellitic acid, glycol esters; esters of saturated alkanediols, for example 2,2,4-trimethylpentane-1,3-diol monoisobutyrate and 2,2,4-trimethylpentane-1,3-diol diisobutyrate.

Examples of polyethers (D) are polyethylene glycols, poly-THF, and polypropylene glycols having average molar masses Mₙ of preferably 200 to 20 000 g/mol.

Plasticizers (D) used are preferably ones having molar masses or—in the case of polymeric plasticizers—average molar masses Mₙ of at least 200 g/mol, more preferably greater than 500 g/mol, especially greater than 900 g/mol. They preferably have molar masses or average molar masses Mₙ of at most 20 000 g/mol, more preferably of at most 10 000 g/mol, especially at most 8000 g/mol.

If non-reactive plasticizers (D) are used according to the invention, the amounts involved are preferably 5 to 300 parts by weight, more preferably 10 to 200 parts by weight, especially 20 to 150 parts by weight, in each case based on 100 parts by weight of component (A). In the compositions of the invention (M), preferably no plasticizers (D) are used.

### Component (E)

Silicone resins (E) optionally used according to the invention are particularly preferably ones that consist to an extent of at least 50% by weight, preferably to an extent of at least 70% by weight, especially to an extent of at least 90% by weight, of T units of the formulas PhSiO_{3/2}, PhSi(OR⁵)O_{2/2}, PhSi(OR⁵)₂O_{1/2}, MeSiO_{3/2}, MeSi(OR⁵)O_{2/2} and/or MeSi(OR⁵)₂O_{1/2}, where Ph is phenyl radical, Me is the methyl radical, and R⁵ is a hydrogen atom or alkyl radicals having 1 to 10 carbon atoms and optionally substituted by halogen atoms, preferably unsubstituted alkyl radicals having 1 to 4 carbon atoms, in each case based on the total number of units. These resins preferably consist to an extent of at least 30% by weight, more preferably to an extent of at least 40% by weight, of the three units having a PhSi function mentioned above.

Silicone resins (E) optionally used according to the invention are especially preferably ones that consist to an extent of at least 50% by weight, preferably to an extent of at least 70% by weight, especially to an extent of at least 90% by weight, of T units of the formulas PhSiO_{3/2}, PhSi(OR⁵)O_{2/2} and/or PhSi(OR⁵)₂O_{1/2}, where all variables are as defined above.

Silicone resins (E) optionally used according to the invention preferably have an average molar mass (number average) Mₙ of at least 400 g/mol and more preferably of at least 600 g/mol. The average molar mass Mₙ of the silicone resins (E) is preferably at most 400 000 g/mol, more preferably at most 10 000 g/mol, especially at most 3000 g/mol.

Silicone resins (E) optionally used according to the invention may be either solid or liquid at 23 °C and 1000 hPa, with preference given to liquid silicone resins (E). The silicone resins (E) preferably have a viscosity of from 10 to 100 000 mPa·s, preferably from 50 to 50 000 mPa·s, especially from 100 to 20 000 mPa·s, in each case at 25 °C.

The silicone resins (E) may be used either in pure form or in the form of a mixture in a suitable solvent, although use in pure form is preferred.

Examples of phenyl silicone resins that may be used as components (E) are commercially available products, for example various SILRES® types from Wacker Chemie AG, such as SILRES® IC 368, SILRES® IC 678 or SILRES® IC 231 and SILRES® SY231.

If resins (E) are used for the compositions of the invention (M), the amounts involved are preferably at least 1 part by weight, more preferably at least 5 parts by weight, especially at least 10 parts by weight and preferably at most 1000 parts by weight, more preferably at most 500 parts by weight, especially at most 300 parts by weight, in each case based on 100 parts by weight of component (A).

### Component (F)

The catalysts (F) optionally used in the compositions of the invention (M) may be any catalysts known to date for compositions that cure by silane condensation.

Examples of metal-containing curing catalysts (F) are organic titanium or tin compounds, for example, titanate esters such as tetrabutyl titanate, tetrapropyl titanate, tetraisopropyl titanate, and titanium tetraacetylacetonate; tin compounds such as dibutyltin dilaurate, dibutyltin maleate, dibutyltin diacetate, dibutyltin dioctanoate, dibutyltin acetylacetonate, dibutyltin oxides, and corresponding dioctyltin compounds.

Examples of metal-free curing catalysts (F) are basic compounds, such as triethylamine, tributylamine, 1,4-diazabicyclo[2.2.2]octane, 1,5-diazabicyclo[4.3.0]non-5-ene, 1,8-diazabicyclo[5.4.0]undec-7-ene, 1,1,2,2-tetramethylguanidine, 1,1,2,3-tetramethylguanidine, N,N-bis(N,N-dimethyl-2-aminoethyl)methylamine, N,N-dimethylcyclohexylamine, N,N-dimethylphenylamine, and N-ethylmorpholine.

Acidic compounds may also be used as catalyst (F), such as phosphoric acid and partially esterified derivatives thereof, toluenesulfonic acid, sulfuric acid, nitric acid or else organic carboxylic acids, for example acetic acid and benzoic acid.

If catalysts (F) are used according to the invention, the amounts involved are preferably 0.01 to 20 parts by weight, more preferably 0.05 to 5 parts by weight, in each case based on 100 parts by weight of constituent (A).

In one execution of the invention, the catalysts (F) optionally used are metal-containing curing catalysts, preferably tin-containing catalysts. This embodiment of the invention is particularly preferred when component (A) consists wholly or at least partly, i.e. to an extent of at least 90% by weight, preferably to an extent of at least 95% by weight, of compounds of the formula (I) in which b is not equal to 1.

In the compositions of the invention (M), metal-containing catalysts (F), and tin-containing catalysts in particular, can preferably be omitted when component (A) consists wholly or at least partly, i.e. to an extent of at least 10% by weight, preferably to an extent of at least 20% by weight, of compounds of the formula (I) in which b is equal to 1 and R¹ is defined as a hydrogen atom.

### Component (G)

The adhesion promoters (G) optionally used according to the invention may be any adhesion promoters described to date for systems that cure by silane condensation.

Examples of adhesion promoters (G) are epoxysilanes, such as glycidoxypropyltrimethoxysilanes, glycidoxypropylmethyldimethoxysilane, glycidoxypropyltriethoxysilane or glycidoxypropylmethyldiethoxysilane, 2-(3-triethoxysilylpropyl)maleic anhydride, N-(3-trimethoxysilylpropyl)urea, N-(3-triethoxysilylpropyl)urea, N-(trimethoxysilylmethyl)urea, N-(methyldimethoxysilylmethyl)urea, N-(3-triethoxysilylmethyl)urea, N-(3-methyldiethoxysilylmethyl)urea, O-methylcarbamatomethylmethyldimethoxysilane, O-methylcarbamatomethyltrimethoxysilane, O-ethylcarbamatomethylmethyldiethoxysilane, O-ethylcarbamatomethyltriethoxysilane, 3-methacryloyloxypropyltrimethoxysilane, methacryloyloxymethyltrimethoxysilane, methacryloyloxymethylmethyldimethoxysilane, methacryloyloxymethyltriethoxysilane, methacryloyloxymethylmethyldiethoxysilane, 3-acryloyloxypropyltrimethoxysilane, acryloyloxymethyltrimethoxysilane, acryloyloxymethylmethyldimethoxysilanes, acryloyloxymethyltriethoxysilane, acryloyloxymethylmethyldiethoxysilane and partial condensates thereof.

If the compositions of the invention (M) contain adhesion promoters (G), the amounts involved are preferably 0.5 to 30 parts by weight, more preferably 1 to 10 parts by weight, in each case based on 100 parts by weight of crosslinkable composition (M).

### Component (H)

Water scavengers (H) optionally used according to the invention may be any water scavengers described for systems that cure by silane condensation.

Examples of water scavengers (H) are silanes such as vinyltrimethoxysilane, vinyltriethoxysilane, vinylmethyldimethoxysilane, phenyltrimethoxysilane, phenyltriethoxysilane, phenylmethyldimethoxysilane, tetraethoxysilane, O-methylcarbamatomethylmethyldimethoxysilane, O-methylcarbamatomethyltrimethoxysilane, O-ethylcarbamatomethylmethyldiethoxysilane, O-ethylcarbamatomethyltriethoxysilane and/or partial condensates thereof and orthoesters such as 1,1,1-trimethoxyethane, 1,1,1-triethoxyethane, trimethoxymethane, and triethoxymethane, with preference given to vinyltrimethoxysilane.

If the compositions of the invention (M) contain water scavengers (H), the amounts involved are preferably 0.5 to 30 parts by weight, more preferably 1 to 10 parts by weight, in each case based on 100 parts by weight of crosslinkable composition (M). The compositions of the invention preferably contain water scavengers (H), more preferably vinyltrimethoxysilane and/or phenyltrimethoxysilane.

### Component (I)

Additives (I) optionally used according to the invention may be any additives known to date that are typical for silane crosslinking systems.

Additives (I) optionally used according to the invention are compounds different from the components mentioned thus far, preferably antioxidants, UV stabilizers, for example so-called HALS compounds, fungicides, commercially available defoamers, for example from Byk (Wesel, Germany), commercially available wetting agents, for example from Byk (Wesel, Germany), or pigments.

If additives (I) are used for production according to the invention of the compositions (M), which constitutes a preferred embodiment, the amounts involved are preferably 0.01 to 30 parts by weight, more preferably 0.1 to 10 parts by weight, in each case based on 100 parts by weight of constituent (A).

### Component (J)

The additional materials (J) optionally used according to the invention are preferably tetraalkoxysilanes, for example tetraethoxysilane, and/or partial condensates thereof, reactive plasticizers, rheology additives, flame retardants or organic solvents.

Preferred reactive plasticizers (J) are compounds that contain alkyl chains having 6 to 40 carbon atoms and have a group reactive toward compounds (A). Examples are isooctyltrimethoxysilane, isooctyltriethoxysilane, N-octyltrimethoxysilane, N-octyltriethoxysilane, decyltrimethoxysilane, decyltriethoxysilane, dodecyltrimethoxysilane, dodecyltriethoxysilane, tetradecyltrimethoxysilane, tetradecyltriethoxysilane, hexadecyltrimethoxysilane, and hexadecyltriethoxysilane.

Flame retardants (J) used may be any flame retardants typical of adhesive and sealant systems, preferably halogenated compounds and (partial) esters of phosphoric acid and derivatives thereof, especially (partial) esters of phosphoric acid.

Examples of organic solvents (J) are low-molecular-weight ethers, esters, ketones, aromatic and aliphatic and optionally halogen-containing hydrocarbons and alcohols, with preference given to the latter.

Preferably no organic solvents (J) are added to the compositions of the invention (M).

If one or more components (J) are used for production according to the invention of the compositions (M), the amounts involved are in each case preferably 0.5 to 200 parts by weight, more preferably 1 to 100 parts by weight, especially 2 to 70 parts by weight, in each case based on 100 parts by weight of component (A).

In a preferred embodiment, the compositions of the invention (M) comprise
(A) 100 parts by weight of compounds of the formula (I),
(B1) 100-1900 parts by weight of fillers (B1),
(B2) 0-1000 parts by weight of fillers (B2),
(B3) 0-500 parts by weight of fillers (B3),
(C) 0.1-50 parts by weight of organosilicon compounds comprising units of the formula (V),
optionally (D) non-reactive plasticizers,
optionally (E) silicone resins,
optionally (F) catalysts,
optionally (G) adhesion promoters,
optionally (H) water scavengers,
optionally (I) additives, and
optionally (J) aggregates.

In a more preferred embodiment, the compositions of the invention (M) comprise
(A) 100 parts by weight of compounds of the formula (I),
(B1) 200-1500 parts by weight of fillers (B1),
(B2) 10-500 parts by weight of fillers (B2),
(B3) 0-200 parts by weight of fillers (B3),
(C) 0.5-30 parts by weight of organosilicon compounds comprising units of the formula (V),
optionally (D) non-reactive plasticizers,
optionally (E) silicone resins,
optionally (F) catalysts,
(G) 0.5-30 parts by weight of water scavengers,
optionally (G) adhesion promoters,
optionally (H) water scavengers,
optionally (I) additives, and
optionally (J) aggregates.

In a particularly preferred embodiment, the compositions of the invention (M) comprise
(A) 100 parts by weight of compounds of the formula (I),
(B1) 300-1200 parts by weight of fillers (B1),
(B2) 50-400 parts by weight of fillers (B2),
(B3) 0-50 parts by weight of fillers (B3),
(C) 0.5-30 parts by weight of organosilicon compounds comprising units of the formula (V),
optionally (D) non-reactive plasticizers,
optionally (E) silicone resins,
optionally (F) catalysts,
(G) 0.5-30 parts by weight of vinyltrimethoxysilane and/or phenyltrimethoxysilane,
optionally (G) adhesion promoters,
optionally (H) water scavengers,
optionally (I) additives, and
optionally (J) aggregates.

The compositions of the invention (M) preferably do not contain any components over and above components (A) to (J). The components used according to the invention may in each case be a single type of such a component or else a mixture of at least two types of a particular component.

The thermally conductive compositions of the invention (M) preferably have a thermal conductivity of at least 1.0 W/mK, more preferably of at least 2.0 W/mK, and especially preferably of at least 3.5 W/mK.

The viscosity of the compositions of the invention (M) may vary over a very wide range and be adapted to the use requirements.

The density of the compositions of the invention (M) is preferably less than 4.5 g/cm³, more preferably less than 4.0 g/cm³, and particularly preferably less than 3.3 g/cm³.

The present invention further provides a process for producing the compositions of the invention (M) by mixing the individual components by the customary continuous or discontinuous mixing processes of the prior art. Suitable mixing apparatuses are all known apparatuses. Examples thereof include uniaxial or biaxial continuous mixers, double rollers, Ross mixers, Hobart mixers, dental mixers, planetary mixers, kneaders, and Henschel mixers or similar mixers.

The compositions of the invention (M) are preferably produced with exclusion of moisture.

The compositions of the invention (M) are one-component crosslinkable compositions, depending on the use requirements in the particular case. The compositions (M) produced according to the invention may however also be part of two-component crosslinking systems in which OH-containing compounds such as water are added in a second component.

The compositions of the invention (M) are storable with exclusion of water and can undergo crosslinking if water gets in.

The present invention therefore further provides the silicone shaped articles obtained by filling or applying and then crosslinking/curing the crosslinkable compositions (M).

The usual water content of air is in many cases sufficient for crosslinking of the compositions of the invention (M). The compositions of the invention (M) are preferably crosslinked at room temperature. They may, if desired, also be crosslinked at temperatures higher or lower than room temperature, for example at −5 °C to 15 °C or at 30 °C to 50 °C and/or using concentrations of water exceeding the normal water content of air.

The shaped articles produced according to the invention preferably have an elongation at break of at least 100%, more preferably of at least 200%, in each case measured according to DIN EN 53504-S1.

The shaped articles produced according to the invention may be any shaped articles, such as seals, molded articles, extruded profiles, coatings, impregnations, potting, lenses, prisms, polygonal structures, laminate layers or adhesive layers.

The present invention further provides for the use of the thermally conductive compositions of the invention (M) as thermally conductive paste, gap filler, thermally conductive pad, thermally conductive adhesives, and potting compounds.

The thermally conductive compositions of the invention (M) are ideal for this, since they permit very good dissipation of heat from heat generators or heat dissipators in electrical and/or electronic apparatuses.

For this, the thermally conductive composition of the invention (M) is applied to heat generators or heat dissipators, or the already crosslinked or cured thermally conductive composition of the invention (M) is introduced as a shaped article, for example as a thermally conductive pad, between the heat generator and/or heat dissipator.

Typical heat generators are found for example in electrical and electronic apparatuses of power supply units and in electronic devices, for example supply transistors, power modules, transistors, thermocouples, and temperature sensors; heat-generating electronic components, for example integrated circuit components such as CPUs and batteries. In the automotive industry heat generators are found in particular in the vicinity of lithium-ion batteries, charging infrastructure, and control devices and sensors. Suitable heat dissipators include heat dissipating components such as heat distributors and heat sinks and cooling fins. If the thermally conductive composition (M) is introduced between a heat generator and a heat dissipator, the heat may be efficiently conducted from the heat generator to the heat dissipator. This achieves effective cooling of the heat generator.

The thermally conductive compositions of the invention (M) are especially suitable for use as gap fillers for lithium-ion batteries of electric vehicles and as a potting compound for electronic components of electric vehicles for example.

The examples that follow describe how the present invention may be executed, but without limiting said invention to what is disclosed therein.

Unless otherwise stated, all work steps in the examples below are carried out at a pressure of the ambient atmosphere, i.e. at 1013 hPa, and at room temperature, i.e. at 23 °C, or at a temperature that is established when the reactants are combined at room temperature without additional heating or cooling. The crosslinking of the compositions (M) is carried out at a relative humidity of 50%. In addition, all stated parts and percentages are based on weight unless otherwise stated.

### EXAMPLES

### Measurement of Thermal Conductivity Lambda

Thermal conductivity is determined according to ASTM D5470-12 using a TIM Tester (Steinbeis Transferzentrum Warmemanagement in der Elektronik, Lindenstr. 13/1, 72141 Walddorfhäslach, Germany). The thermal resistance of the sample arranged between 2 test cylinders is determined via a constant heat flow. The effective thermal conductivity of the sample is calculated over the layer thickness of the sample.

For the measurement, the sample is applied using a stencil and the measuring cylinders are manually brought together to a thickness of 1.9-2.0 mm, after which excess material is removed. Measurement of thermal conductivity is carried out at a constant gap of 1.8-1.6-1.4-1.2-1.0 mm. The evaluations are performed via an integrated report generation function.

After a plausibility test (straight-line coefficient of determination >0.998) the thermal conductivity is displayed as the effective thermal conductivity λ_{eff} in W/(mK).

### Particle Size/Shape Analysis

Analysis of particle size (median diameter ×50), particle size distribution (parameter: standard deviation sigma and distribution width span), and particle shape (parameter: aspect ratio w/l) was carried out with a Camsizer X2 from Retsch Technology (measurement principle: dynamic image analysis) in accordance with ISO 13322-2 and ISO 9276-6 (analysis type: dry measurement of powders and granulates; measurement range: 0.8 μm to 30 mm; compressed air dispersion with “X-Jet”; dispersion pressure=0.3 bar). Evaluations were performed on a volume basis according to the x_{c min} model.

### Example 1: Preparation of a Mixture of Silane-Terminated Polypropylene Glycols as Component (A)

A 2000 ml three-necked flask equipped with thermometer, reflux condenser, stirrer, and heating means is initially charged with 400.0 g (22.2 mmol) of a bilaterally hydroxy-terminated polypropylene glycol having a number-average molar mass Mₙ of 18 000 g/mol (commercially available under the Acclaim® 18200 name from Covestro AG, Leverkusen, Germany) and dried for 2 h at 80 °C and 1 mbar with stirring. The vacuum is then released with nitrogen. The entire reaction that follows is carried out under a nitrogen inert gas atmosphere.

To perform the silane termination, first 27.4 g (133.2 mmol) of 3-isocyanatopropyltrimethoxysilane (commercially available under the Geniosil® GF40 name from Wacker Chemie AG, Munich, Germany) is added dropwise to the dried polyether at 80 °C and then 0.31 g of Borchi Catalyst 315 (a bismuth neodecanoate-containing catalyst from Borchers) is added using an Eppendorf pipette. Immediately after the addition of catalyst, the reaction mixture is heated to 82-83 °C. It is then stirred at a temperature of 80 °C.

After 60 min, 484 g (96.8 mmol) of a monohydroxy-monobutoxy-terminated polypropylene glycol having an average molar mass Mₙ of 5000 g/mol (commercially available under the Preminol® S 1005 name from AGC Chemicals Europe, LTD, Amsterdam, The Netherlands) is added at unchanged temperature. The mixture is then stirred at 80 °C for a further 60 min. The reaction mixture is then cooled to room temperature and a sample is taken and investigated by IR analysis for any residual isocyanatosilane that might still be present. The sample is isocyanate-free.

### Example 2: Preparation of a Silane-Terminated Polypropylene Glycol as Component (A)

A 2000 ml four-necked flask equipped with dropping funnel, reflux condenser, thermometer, stirrer, and heating means is initially charged with 1080 g (270 mmol) of a bilaterally hydroxy-terminated polypropylene glycol having a number-average molecular mass of 4000 g/mol (commercially available under the Acclaim® 4200 name from Covestro AG, Leverkusen, Germany) and dried for 2 h at 80 °C and 1 mbar with stirring. The vacuum is then released with nitrogen. The entire reaction that follows is carried out under a nitrogen inert gas atmosphere.

To perform the silane termination, 91.4 g (567 mmol) of a-isocyanatomethylmethyldimethoxysilane (Geniosil® XL 42, commercially available from Wacker Chemie AG, Munich, Germany) is added dropwise to the dried polyether at 80 °C over 15 minutes with stirring. The temperature remains at 80 °C. 0.17 g of Borchi Catalyst 315 (a bismuth neodecanoate-containing catalyst from Borchers) is then added using an Eppendorf pipette. This corresponds to a value of 150 ppm of catalyst based on the total weight of the reaction mixture. A slight warming of the reaction mixture occurs (<5 °C). The mixture is then stirred at 80 °C for 2 hours. After this time, a small isocyanate peak is still present in the IR spectrum of the reaction mass.

18.9 g (54 mmol) of a monohydroxy-monomethoxy-terminated polyethylene glycol having an average molar mass Mₙ of 350 g/mol (commercially available under the PEG 350M name from Clariant, Gendorf, Germany) is then added at unchanged temperature. The mixture is then stirred at 80 °C for a further 15 min. The reaction mixture is then cooled to room temperature and a sample is taken and investigated by IR analysis for any residual isocyanatosilane that might still be present. The sample is isocyanate-free.

### Example 3a: Preparation of an Inventive Thermally Conductive Composition (M)

In a laboratory planetary mixer from PC-Laborsystem equipped with two cross-arm mixers, 34 g of a polypropylene glycol silane-terminated at one end and having an average molar mass (Mₙ) of 5000 g/mol and end groups of the formula —O—C(═O)—NH—(CH₂)₃—Si(OCH₃)₃ (commercially available under the Geniosil® XM25 name from Wacker Chemie AG, Munich, Germany) is homogenized at 200 rpm for 2 minutes at approx. 25 °C with 4.8 g of vinyltrimethoxysilane and 1.0 g of a stabilizer mixture (mixture of 20% Irganox® 1135 (CAS No. 125643-61-0), 40% Tinuvin® 571 (CAS No. 23328-53-2), and 40% Tinuvin® 765 (CAS No. 41556-26-7), commercially available under the Tinuvin® B 75 name from BASF SE, Germany).

136 g of predominantly round silicon particles having a median diameter ×50 of 49.1 μm, a distribution width span of 0.96 (×10=21.8 μm; ×90=69.0 μm), and an aspect ratio w/1 of 0.86, 136 g of predominantly round silicon particles having a median diameter ×50 of 82.9 μm, a distribution width span of 0.85 (×10=55.7 μm; ×90=125.8 μm), and an aspect ratio w/1 of 0.83, and 87 g of zinc oxide (commercially available under the Zinc Oxide Grade AZO 66 name from U.S. Zinc, Houston, United States) are then successively digested with stirring for one minute at 600 rpm. Lastly, 1.2 g of N-(2-aminoethyl)-3-aminopropyltrimethoxysilane is mixed in at 200 rpm for 1 minute. Finally, the mixture is homogenized and stirred with avoidance of air bubbles at a pressure of 100 mbar for 2 minutes at 600 rpm and for 1 minute at 200 rpm.

The prepared composition is transferred to airtight closable containers. It is suitable for use inter alia as a thermally conductive adhesive, gap filler, potting compound or, in the cured state, as a thermally conductive pad.

### Example 3b: Preparation of an Inventive Thermally Conductive Composition (M)

The procedure is the same as in example 3a but using as component (A), in place of the 34 g of Geniosil® XM 25, the same amount of the mixture of silane-terminated polypropylene glycols prepared in example 1.

Here, too, the prepared composition is transferred to airtight closable containers and is suitable for use inter alia as a thermally conductive adhesive, gap filler, potting compound or, in the cured state, as a thermally conductive pad.

### Example 3c: Preparation of an Inventive Thermally Conductive Composition (M)

The procedure is the same as in example 3a but using as component (A), in place of the 34 g of Geniosil® XM 25, the same amount of the silane-terminated polypropylene glycol prepared in example 2.

Here, too, the prepared composition is transferred to airtight closable containers and is suitable for use inter alia as a thermally conductive adhesive, gap filler, potting compound or, in the cured state, as a thermally conductive pad.

### Comparative Example 1a: Preparation of a Noninventive Moisture-Curable Composition

In a laboratory planetary mixer from PC-Laborsystem equipped with two cross-arm mixers, 95.8 g of Geniosil® XM25 is homogenized at 200 rpm for 2 minutes at approx. 25 °C 2.0 g of vinyltrimethoxysilane, 1.0 g of a stabilizer mixture (mixture of 20% Irganox® 1135 (CAS No. 125643-61-0), 40% Tinuvin® 571 (CAS No. 23328-53-2), and 40% Tinuvin® 765 (CAS No. 41556-26-7), commercially available under the Tinuvin® B 75 name from BASF SE, Germany), 1.0 g of N-(2-aminoethyl)-3-aminopropyltrimethoxysilane, and 0.2 g of dioctyltin dilaurate.

The prepared composition is transferred to airtight closable containers.

### Comparative Example 1b: Preparation of a Noninventive Moisture-Curable Composition

The procedure is the same as in comparative example 1a but using as component (A), in place of the Geniosil® SX 25, the same amount of the mixture of silane-terminated polypropylene glycols prepared in example 1.

Here, too, the prepared composition is transferred to an airtight closable container.

### Comparative Example 1c: Preparation of a Noninventive Moisture-Curable Composition

The procedure is the same as in comparative example 1a but using as component (A), in place of the Geniosil® SX 25, the same amount of the silane-terminated polypropylene glycol prepared in example 2.

### Comparative Example 2a: Preparation of a Noninventive Thermally Conductive Composition

In a laboratory planetary mixer from PC-Laborsystem equipped with two cross-arm mixers, 34 g of Geniosil® XM25 is homogenized at 200 rpm for 2 minutes at approx. 25 °C with 4.8 g of vinyltrimethoxysilane and 1.0 g of a stabilizer mixture (mixture of 20% Irganox© 1135 (CAS No. 125643-61-0), 40% Tinuvin® 571 (CAS No. 23328-53-2), and 40% Tinuvin® 765 (CAS No. 41556-26-7), commercially available under the Tinuvin® B 75 name from BASF SE, Germany).

136 g of predominantly round aluminum oxide particles having a median diameter ×50 of 50 μm (commercially available under the Alunabeads™ CB A50 name from Showa Denko, Tokyo, Japan), 136 g of a calcined aluminum oxide having a median diameter ×50 of 3 μm (commercially available under the Alumina CL 3000 SG name from Almatis, Ludwigshafen, Germany), and 87 g of zinc oxide (commercially available under the Zinc Oxide Grade AZO 66 name from U.S. Zinc, Houston, United States) are then successively digested with stirring for one minute at 600 rpm. Lastly, 1.2 g of N-(2-aminoethyl)-3-aminopropyltrimethoxysilane is mixed in at 200 rpm for 1 minute. Finally, the mixture is homogenized and stirred with avoidance of air bubbles at a pressure of 100 mbar for 2 minutes at 600 rpm and for 1 minute at 200 rpm.

The prepared composition is transferred to airtight closable containers.

### Comparative Example 2b: Preparation of a Noninventive Thermally Conductive Composition (M)

The procedure is the same as in comparative example 2a but using as component (A), in place of the 34 g of Geniosil® SX 25, the same amount of the mixture of silane-terminated polypropylene glycols prepared in example 1.

Here, too, the prepared composition is transferred to airtight closable containers.

### Comparative Example 2c: Preparation of a Noninventive Thermally Conductive Composition (M)

The procedure is the same as in comparative example 2a but using as component (A), in place of the 34 g of Geniosil® SX 25, the same amount of the silane-terminated polypropylene glycol prepared in example 2.

Here, too, the prepared composition is transferred to airtight closable containers.

### Example 4: Measurement of Thermal Conductivity

The thermal conductivity of the compositions (M) prepared in examples 3a to 3c and in comparative examples 1a to 1c and 2a to 2c is measured as described above. The results are shown in Table 1.

TABLE 1

| | Thermal conductivity λ_{eff} |
|---|---|
| Composition (M) | [W/mK] |
| Example 3a | 4.5 |
| Example 3b | 4.3 |
| Example 3c | 4.6 |
| Comparative example 1a | 0.17 |
| Comparative example 1b | 0.17 |
| Comparative example 1c | 0.16 |
| Comparative example 2a | 3.0 |
| Comparative example 2b | 2.8 |
| Comparative example 2c | 3.1 |

### Example 5: Determination of the Properties of the Samples from Examples 3b and 3c

### Skin Formation Time (SFT)

To determine the skin formation time, the crosslinkable compositions obtained in the examples are applied in a 2 mm thick layer on PE film and stored at standard climatic conditions (23 °C and 50% relative humidity). During curing, the formation of a skin is tested every 5 minutes. This is done by carefully placing a dry laboratory spatula on the surface of the sample and pulling upward. If sample sticks to the spatula, a skin has not yet formed. If no sample remains stuck to the spatula, a skin has formed and the time is noted. The results are shown in Table 2.

### Mechanical Properties

The compositions were each spread on milled Teflon panels to a depth of 2 mm and cured for 2 weeks at 23 °C and 50% relative humidity.

The Shore A hardness is determined in accordance with DIN EN 53505.

The tensile strength is determined in accordance with DIN EN 53504-Si.

The elongation at break is determined in accordance with DIN EN 53504-S1.

The results are shown in Table 2.

TABLE 2

| Composition from example | 3b | 3c |
|---|---|---|
| SFT [min] | 23 | 17 |
| Shore A hardness | 96 | 98 |
| Tensile strength [N/mm²] | 3.5 | 4.0 |
| Elongation at break [%] | 15 | 10 |

1-10. (canceled)

11. A crosslinkable, thermally conductive composition (M), comprising:
100 parts by weight of at least one compound (A) of the formula (I)
Y[(CR¹₂)_{b}—SiRₐ(OR²)₃₋ₐ]ₓ (I),
wherein Y is an x-valent organic polymer radical attached via nitrogen, oxygen, sulfur or carbon,
wherein R may be identical or different and is a monovalent, optionally substituted hydrocarbon radical,
wherein R¹ may be identical or different and is a hydrogen atom or a monovalent, optionally substituted hydrocarbon radical that can be attached to the carbon atom via nitrogen, phosphorus, oxygen, sulfur or a carbonyl group,
wherein R² may be identical or different and is a hydrogen atom or a monovalent, optionally substituted hydrocarbon radical,
wherein x is an integer from 1 to 10,
wherein a may be identical or different and is 0, 1 or 2, and
wherein b may be identical or different and is an integer from 1 to 10;
100 to 1900 parts by weight of at least one filler (B); and
wherein at least 30% by weight of all fillers (B) consists of metallic silicon particles (B1).

12. The crosslinkable composition (M) of claim 11, wherein at least 40% by weight of all the at least one filler (B) consist of metallic silicon particles (B1).

13. The crosslinkable composition (M) of claim 11, wherein the at least one filler (B) comprises at least one further thermally conductive filler (B2) that consists of materials having a thermal conductivity of at least 5 W/mK.

14. The crosslinkable composition (M) of claim 13, wherein at least 60% by weight of the at least one filler (B) consists of metallic silicon particles (B1) and further fillers (B2).

15. The crosslinkable composition (M) of claim 11, wherein the metallic silicon particles (B1) contain less than 20% by weight of a particle fraction having a diameter of less than or equal to 20 μm, based on the total amount of metallic silicon particles (B1).

16. The crosslinkable composition (M) of claim 11, wherein the crosslinkable, thermally conductive composition (M) is used within a thermally conductive paste, a gap filler, thermally conductive adhesives, and potting compounds.

17. A process for producing a crosslinkable, thermally conductive composition (M), comprising:
providing 100 parts by weight of at least one compound (A) of the formula (I)
Y[(CR¹₂)_{b}—SiRₐ(OR²)₃₋ₐ]ₓ (I),
wherein Y is an x-valent organic polymer radical attached via nitrogen, oxygen, sulfur or carbon,
wherein R may be identical or different and is a monovalent, optionally substituted hydrocarbon radical,
wherein R¹ may be identical or different and is a hydrogen atom or a monovalent, optionally substituted hydrocarbon radical that can be attached to the carbon atom via nitrogen, phosphorus, oxygen, sulfur or a carbonyl group,
wherein R² may be identical or different and is a hydrogen atom or a monovalent, optionally substituted hydrocarbon radical,
wherein x is an integer from 1 to 10,
wherein a may be identical or different and is 0, 1 or 2, and
wherein b may be identical or different and is an integer from 1 to 10;
providing 100 to 1900 parts by weight of at least one filler (B), wherein at least 30% by weight of all fillers (B) consists of metallic silicon particles (B1); and
mixing continuously or discontinuously the individual components.

18. The process of claim 17, wherein the production takes place with exclusion of moisture.

19. A silicone shaped article, comprising:
wherein the silicone shaped article is obtainable by filling or applying and then crosslinking or curing a crosslinkable, thermally conductive composition (M);
wherein the crosslinkable, thermally conductive composition (M) comprises
100 parts by weight of at least one compound (A) of the formula (I)
Y—[(CR¹₂)_{b}—SiRₐ(OR²)₃₋ₐ]ₓ (I),
wherein Y is an x-valent organic polymer radical attached via nitrogen, oxygen, sulfur or carbon,
wherein R may be identical or different and is a monovalent, optionally substituted hydrocarbon radical,
wherein R¹ may be identical or different and is a hydrogen atom or a monovalent, optionally substituted hydrocarbon radical that can be attached to the carbon atom via nitrogen, phosphorus, oxygen, sulfur or a carbonyl group,
wherein R² may be identical or different and is a hydrogen atom or a monovalent, optionally substituted hydrocarbon radical,
wherein x is an integer from 1 to 10,
wherein a may be identical or different and is 0, 1 or 2, and
wherein b may be identical or different and is an integer from 1 to 10; and
100 to 1900 parts by weight of at least one filler (B) and wherein at least 30% by weight of all fillers (B) consists of metallic silicon particles (B1).

20. The silicone shaped article of claim 19, wherein the silicone shaped article is a thermally conductive pad.
